(19) United States
(12) Patent Application Publication
(10) Pub. No.: US 2023/0195942 A1
(43) Pub. Date: Jun. 22, 2023

(54) DATA PROCESSING METHOD AND APPARATUS, AND STORAGE MEDIUM

(71) Applicant: Beijing Wodong Tianjun Information Technology Co., Ltd., Beijing (CN)

(72) Inventors: Jinbo SONG, Beijing (CN); Yafei YAO, Beijing (CN); Yong LI, Beijing (CN); Changping PENG, Beijing (CN); Yongjun BAO, Beijing (CN); Jingping SHAO, Beijing (CN)

(21) Appl. No.: 18/083,611

(22) Filed: Dec. 19, 2022

(30) Foreign Application Priority Data
Dec. 22, 2021 (CN) 202111583155.9

(51) Int. Cl. G06F 21/71

(52) U.S. Cl. CPC G06F 21/71

(57) ABSTRACT

Provided is a data processing method and apparatus and a storage medium. Object attribute information, historical behavior data and historical display data corresponding to the object attribute information are extracted from historical log data. Historical recommendation data corresponding to the object attribute information is acquired from a historical recommendation information base. The historical recommendation data is searched for first historical recommendation data which is the same as the historical display data. Second historical recommendation data is obtained according to the historical display data, historical behavior data and the first historical recommendation data. A preset recommendation model is trained by using the second historical recommendation data and the third historical recommendation data to obtain a trained preset recommendation model. Upon reception of first identity attribute information, recommendation data corresponding to the first identity attribute information is determined based on the trained preset recommendation model.

### CROSS REFERENCE TO RELATED APPLICATION

The application is based on and claims priority to Chinese Patent Application No. 202111583155.9, filed on Dec. 22, 2021, the disclosure of which is incorporated herein by reference in its entirety.

### TECHNICAL FIELD

The present disclosure relates to the technical field of computers, and particularly to a data processing method and apparatus and a storage medium.

### BACKGROUND

Due to the large scale of a commodity library, in order to meet the demand of recommending commodities to customers in real time, at present, a recommendation system is usually used to select commodities related to a user from the commodity library according to the attribute information of the user, and then recommend same to the user. However, in the process of model training of the existing recommendation system, the accuracy of the trained recommendation system is low due to the simplicity of samples.

### SUMMARY

According to a first aspect, the embodiments of the present disclosure provide a data processing method, which may include the following operations.

Object attribute information, and historical behavior data and historical display data corresponding to the object attribute information are extracted from historical log data; and historical recommendation data corresponding to the object attribute information is acquired from a historical recommendation information base. The historical recommendation data includes the historical display data.

The historical recommendation data is searched for first historical recommendation data which is the same as the historical display data; and second historical recommendation data is obtained according to the historical display data, the historical behavior data and the first historical recommendation data.

A preset recommendation model is trained by using the second historical recommendation data and the third historical recommendation data to obtain a trained preset recommendation model. The third historical recommendation data is historical recommendation data other than the first historical recommendation data among the historical recommendation data.

Upon reception of first identity attribute information, recommendation data corresponding to the first identity attribute information is determined based on the trained preset recommendation model.

According to a second aspect, the embodiments of the present disclosure provide a data processing apparatus, which may include an acquisition unit, a searching unit, a model training unit, and a determination unit.

The acquisition unit is configured to extract object attribute information, historical behavior data and historical display data corresponding to the object attribute information from historical log data; and acquire historical recommendation data corresponding to the object attribute information from a historical recommendation information base. The historical recommendation data includes the historical display data.

The searching unit is configured to search the historical recommendation data for first historical recommendation data which is the same as the historical display data; and obtain second historical recommendation data according to the historical display data, the historical behavior data and the first historical recommendation data.

The model training unit is configured to train a preset recommendation model by using the second historical recommendation data and the third historical recommendation data, to obtain a trained preset recommendation model. The third historical recommendation data is historical recommendation data other than the first historical recommendation data among the historical recommendation data.

The determination unit is configured to determine, upon reception of first identity attribute information, recommendation data corresponding to the first identity attribute information based on the trained preset recommendation model.

According to a third aspect, the embodiments of the present disclosure provide a data processing device, which may include: a processor, a memory and a communication bus. The processor implements the data processing method as described in any of the above when executing a running program stored in the memory.

According to a fourth aspect, the embodiments of the present disclosure provide a storage medium, having a computer program stored thereon. The computer program, when executed by a processor, implements the data processing method as described in any of the above.

### BRIEF DESCRIPTION OF THE DRAWINGS

FIG. 1 is a schematic diagram of an exemplary recommendation apparatus according to an embodiment of the present disclosure.

FIG. 2 is a flowchart of a data processing method according to an embodiment of the present disclosure.

FIG. 3 is a schematic diagram of an exemplary data processing apparatus according to an embodiment of the present disclosure.

FIG. 4 is a structural composition diagram of a data processing apparatus according to an embodiment of the present disclosure.

FIG. 5 is a structural composition diagram of a data processing device according to an embodiment of the present disclosure.

### DETAILED DESCRIPTION

It is to be understood that the specific embodiments described herein are merely used to explain the present disclosure, but not to limit the present disclosure.

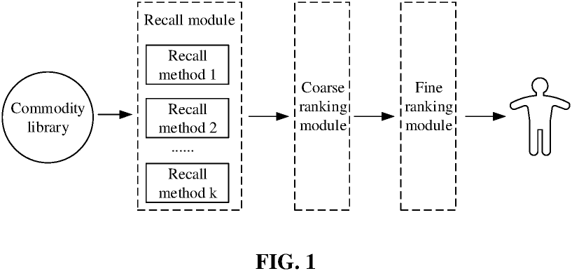

The present disclosure is an improvement to a recommendation apparatus. FIG. 1 is a schematic diagram of an exemplary recommendation apparatus according to the embodiment of the present disclosure. As shown in FIG. 1, the recommendation apparatus includes three modules, i.e., a recall module, a coarse ranking module and a fine ranking module.

The recall module is configured to search a commodity library for one or more commodities related to a user by using different recall methods, and return recall results to the coarse ranking module.

The coarse ranking module is configured to perform Click Through Rate (CTR) prediction on the obtained recall results by using a trained coarse ranking CTR prediction model, and return a top preset number of commodities to the fine ranking module after ranking the recall results according to prediction results, for example, returning the top 100 commodities to the fine ranking module.

The fine ranking module, which uses the same method as the coarse ranking module, is configured to select one or more final recommended commodities from the preset number of commodities and display the final recommended commodities in a display interface for the user to operate.

However, in an existing recommendation apparatus, only the historical display data displayed in a user display interface is used for training a coarse ranking CTR prediction model, which leads to the problem of sample selection bias, and then leads to low prediction accuracy of the coarse ranking CTR prediction model.

Based on the above technical problem, the present disclosure proposes a data processing method, which can solve the problem of sample bias in the existing recommendation apparatus, and further improve the accuracy of recommendation.

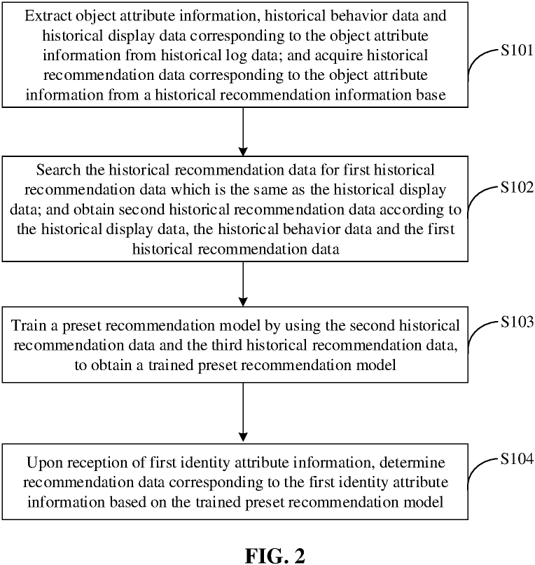

The embodiments of the present disclosure provide a data processing method, which is applied to a data processing apparatus. FIG. 2 is a flowchart of a data processing method according to an embodiment of the present disclosure. As shown in FIG. 2, the data processing method may include the following operations.

At S101, object attribute information, and historical behavior data and historical display data corresponding to the object attribute information are extracted from historical log data; and historical recommendation data corresponding to the object attribute information is acquired from a historical recommendation information base.

The data processing method proposed in the embodiment of the present disclosure may be applied to a scenario of recommending commodities to a user.

In the embodiment of the present disclosure, the data processing apparatus extracts object attribute information, historical behavior data and historical display data corresponding to the object attribute information from historical log data; and acquires historical recommendation data corresponding to the object attribute information from a historical recommendation information base.

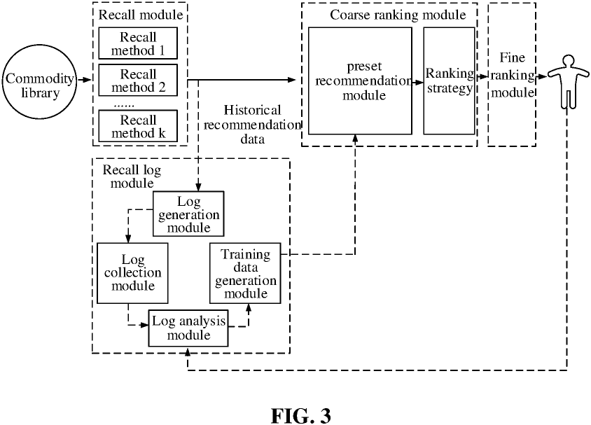

Referring to FIG. 3, FIG. 3 is a schematic diagram of an exemplary data processing apparatus according to an embodiment of the present disclosure. Herein, compared with FIG. 1, in the data processing apparatus as shown in FIG. 3, a recall log module is added between the recall module and the coarse ranking module, and a ranking strategy is added in the coarse ranking module. It is to be noted that the recall log module is configured to acquire historical recommendation data from the recall module, generate historical display data and historical behavior data, and then perform data processing on the historical recommendation data, historical display data and historical behavior data, so as to generate a training sample for training the preset recommendation model, and the ranking strategy is applied to a process of ranking the to-be-recommended data to select the recommendation data in the data recommendation process by using the trained preset recommendation model.

Specifically, the recall log module is composed of a log generation module, a log collection module, a log analysis module and a training data generation module. The log generation module is configured to acquire object attribute information, historical behavior data and historical display data from historical log data. The log collection module is configured to acquire the historical recommendation data corresponding to the object attribute information from the historical recommendation information base.

It is to be noted that the object attribute information may be user attribute information, such as user Identity Document (ID), age of the user, and location of the user. The specific object attribute information is determined according to an actual situation, which is not limited here in the embodiment of the present disclosure.

It is to be noted that the historical behavior data may be the historical behavior data of the user (an object), such as historical browsing data, historical query data, historical add-to-cart data, historical purchase data and historical comments. The specific historical behavior data is determined according to the actual situation, which is not limited here in the embodiment of the present disclosure.

It is to be noted that the historical display data may be data displayed in the display interface of the user historically. For example, after a user A starts a shopping APP, the commodity data displayed in the display interface of the shopping APP to the user is the historical display data. The specific historical display data is determined according to the actual situation, which is not limited here in the embodiment of the present disclosure.

It is to be noted that the historical display data includes commodity data, such as a serial number corresponding to a commodity, a category to which the commodity belongs, a price of the commodity, and the like. The specific commodity data is determined according to the actual situation, which is not limited here in the embodiment of the present disclosure.

In the embodiment of the present disclosure, the historical recommendation data in the historical recommendation information base is generated by the recall module in FIG. 2, and “recall” may be understood as retrieving information related to the user from a material base according to behavior, portrait, and other information of the user. There may be a plurality of recall methods, such as “regional-based recall” and “age-based recall”. Commodities in a target database are scored by the two recall methods respectively, and finally for each of the commodities, the scores obtained by the two methods are combined to obtain a final score. At this time, each of commodities having a score greater than a preset numerical value is the historical recommendation data. The specific preset value and recall method are determined according to the actual situation, which are not limited here in the embodiment of the present disclosure.

It is to be noted that the historical recommendation data includes historical display data. Specifically, among the historical recommendation data, the recommendation data that is displayed in the display interface historically is the historical display data.

At S102, the historical recommendation data is searched for first historical recommendation data which is the same as the historical display data; second historical recommendation data is obtained according to the historical display data, the historical behavior data and the first historical recommendation data.

In the embodiment of the present disclosure, after obtaining the historical recommendation data, the data processing apparatus searches the historical recommendation data for the first historical recommendation data which is the same as the historical display data, and obtains second historical recommendation data according to the historical display data, the historical behavior data and the first historical recommendation data.

It is to be noted that the log analysis module in the recall log module in FIG. 3 is configured to obtain the second historical recommendation data according to the historical display data, the historical behavior data and the first historical recommendation data.

It is to be noted that the second historical recommendation data is composed of recommendation display click data and recommendation display non-click data.

Specifically, data splicing is performed on the historical display data and the first historical recommendation data to obtain recommendation display data; the recommendation display data is classified into the recommendation display click data and the recommendation display non-click data according to the historical behavior data; and the recommendation display click data and the recommendation display non-click data are determined as the second historical recommendation data.

It is to be noted that the recommendation display data may be obtained by performing data splicing on the historical display data and the first historical recommendation data, and then data that has been clicked in the recommendation display data is acquired through the historical behavior data, so that the recommendation display data may be classified into the recommendation display click data and the recommendation display non-click data.

It is to be understood that by classifying the recommendation display data into the recommendation display click data and the recommendation display non-click data according to the historical behavior data, and then training the preset recommendation model by using the recommendation display click data and the recommendation display non-click data, the number of the data types during the training is increased, and accordingly, the accuracy of model training is further improved.

At S103, a preset recommendation model is trained by using the second historical recommendation data and the third historical recommendation data, to obtain a trained preset recommendation model.

In the embodiment of the present disclosure, after obtaining the second historical recommendation data, the data processing apparatus trains the preset recommendation model by using the second historical recommendation data and the third historical recommendation data, to obtain the trained preset recommendation model.

In the embodiment of the present disclosure, the data processing device needs to first acquire the third historical recommendation data (recommendation non-display data) from the historical recommendation data after obtaining the second historical recommendation data (recommendation display click data and recommendation display non-click data).

In the embodiment of the present disclosure, the third historical recommendation data is historical recommendation data other than the first historical recommendation data among the historical recommendation data.

It is to be noted that part of the historical recommendation data is displayed as historical display data, and therefore the remaining part of the historical recommendation data is non-displayed historical recommendation data, that is, recommendation non-display data.

In the embodiment of the present disclosure, after obtaining the recommendation display click data, the recommendation display non-click data and the recommendation non-display data, the data processing device trains the preset recommendation model by using the recommendation display click data, the recommendation display non-click data and the recommendation non-display data, to obtain the trained preset recommendation model.

It is to be noted that the preset recommendation model may be a CTR model, and the specific preset recommendation model is determined according to the actual situation, which is not limited here in the embodiment of the present disclosure.

Specifically, each piece of the recommendation display click data, the recommendation display non-click data and the recommendation non-display data is sequentially input to the preset recommendation model, to obtain a predicted recommendation display click rate, a predicted recommendation display non-click rate and a predicted recommendation non-display rate corresponding to the each piece of data; and the preset recommendation model is trained based on the predicted recommendation display click rate, the predicted recommendation display non-click rate and the predicted recommendation non-display rate.

It is to be noted that, for these three types of training data, the embodiment of the present disclosure chooses a cross entropy loss function for training in the process of training the preset recommendation model, and other loss functions may also be used for model training in practical application, which is not limited here in the embodiment of the present disclosure.

It is to be noted that when data is input to the preset recommendation model, the output results include three values. Exemplarily, the output results may be a predicted recommendation display click rate of 50%, a predicted recommendation display non-click rate of 30% and a predicted recommendation non-display rate of 20%, and the sum of the three values is always equal to 1.

In the embodiment of the present disclosure, before the preset recommendation model is trained by using the recommendation display click data, the recommendation display non-click data and the recommendation non-display data, first recommendation display click data, first recommendation display non-click data and first recommendation non-display data in a preset proportion may also be selected from the recommendation display click data, the recommendation display non-click data and the recommendation non-display data, to train the preset recommendation model.

In the embodiment of the present disclosure, the recommendation display click data, the recommendation display non-click data and the recommendation non-display data are obtained by the log analysis module of the recall log module in FIG. 3. At this time, the proportion of the numbers of pieces of the data may be uneven, which may also affect the final model training result. Therefore, the preset proportion of data needs to be extracted from the recommendation display click data, the recommendation display non-click data and the recommendation non-display data by the training data generation module of the recall log module in FIG. 3, to train the preset recommendation model. For example, supposing that 100 pieces of recommendation display click data, 200 pieces of recommendation display non-click data and 300 pieces of recommendation non-display data are obtained at this time, and the preset proportion is set to 1: 1: 1, it is necessary at this time to select 100 pieces of data from the 200 pieces of recommendation display non-click data and 100 pieces of data from the 300 pieces of recommendation non-display data, and train the preset recommendation model together with the 100 pieces of recommendation display click data as samples. The specific preset proportion is determined according to the actual situation, which is not limited here in the embodiment of the present disclosure.

It is to be noted that the training data generation module in the recall log module in FIG. 3 is configured to perform feature extraction on the object attribute information obtained by the log generation module, and train the preset recommendation model by using the extracted attribute features, thus improving the prediction accuracy of the preset recommendation model after training.

It is to be understood that, during training of the preset recommendation model, not only the second historical recommendation data (recommendation display click data and recommendation display non-click data) is acquired, but also the third historical recommendation data (recommendation not-display data) is acquired from the historical recommendation data, and then the acquired three types of data are input to the preset recommendation model for training, so that the preset recommendation model can be comprehensively trained by using data in various dimensions, thus improving the prediction rate of the preset recommendation model.

At S104, upon reception of first identity attribute information, recommendation data corresponding to the first identity attribute information is determined based on the trained preset recommendation model.

In the embodiment of the present disclosure, after training the preset recommendation model, the data processing apparatus determines the recommendation data corresponding to the first identity attribute information based on the trained preset recommendation model upon reception of first identity attribute information.

It is to be noted that the first identity attribute information is information required by the user for logging in the data processing apparatus, such as account information or mobile phone number, and the data processing apparatus may be an apparatus for deploying application software.

It is to be noted that the coarse ranking module in FIG. 3 is configured to determine the recommendation data corresponding to the first identity attribute information by using the trained preset recommendation model.

Specifically, upon reception of the first identity attribute information, the target database is searched for to-be-recommended data corresponding to the first identity attribute information; the to-be-recommended data is input to the trained preset recommendation model to obtain a recommendation display click rate, and a recommendation display non-click rate and a recommendation non-display rate corresponding to the to-be-recommended data; and the recommendation data corresponding to the first identity attribute information is determined from the to-be-recommended data, according to the recommendation display click rate, the recommendation display non-click rate and the recommendation non-display rate.

It is to be noted that the target database is the commodity library in FIG. 3, and the target database is searched for the commodities related to the first identity attribute information as to-be-recommended data according to the first identity attribute information.

It is to be noted that, after the to-be-recommended data is obtained, all pieces of data in the to-be-recommended data are sequentially input to the trained preset recommendation model to obtain output results, each corresponding to a respective piece of data, namely the recommendation display click rate, the recommendation display non-click rate and the recommendation non-display rate. Finally, the recommendation data is determined from the to-be-recommended data according to the output results and then input to the fine ranking module as shown in FIG. 3, and finally a result is displayed in the display interface.

It is to be noted that the ranking strategy in the coarse ranking module in FIG. 3 is used to rank the to-be-recommended data, and then determine the recommendation data from the ranked to-be-recommended data.

Specifically, for each piece of the to-be-recommended data, a recommendation index is determined according to the recommendation display click rate, the recommendation display non-click rate and the recommendation non-display rate; the to-be-recommended data is ranked according to an order of recommendation indexes of all pieces of the to-be-recommended data from high to low to obtain the ranked to-be-recommended data; and a preset number of pieces of the to-be-recommended data is selected from the ranked to-be-recommended data, and the preset number of pieces of the to-be-recommended data is determined as the recommendation data corresponding to the first identity attribute information.

In the embodiment of the present disclosure, the recommendation display click rate is P₁, the recommendation display non-click rate is P₂, and the recommendation non-display rate is P₃. Before the recommendation index is calculated, it is necessary to calculate the recommendation display rate P₄ as P₁+P₂, and then the recommendation index is obtained by the following formula:

$$S = {\text{P}}_{1}^{\text{t1}} \times {\text{P}}_{4}^{\text{t2}}$$

In the above formula (1), t1 is a first parameter configured for P₁, and t2 is a second parameter configured for P₄.

It is to be noted that, since the recommendation non-display rate P₃ is considered not to have the possibility of being clicked in the actual situation, the to-be-recommended data of which the P₃ value is higher than a preset threshold may be put in the back position, and then, for the to-be-recommended data of which the P₃ value is lower than the preset threshold, the recommendation index is calculated according to the method in formula (1), and the to-be-recommended data of which the P₃ value is lower than the preset threshold is ranked in the front according to the recommendation index.

It is to be noted that P₁ and P₂ may also be directly used to calculate the recommendation index of the to-be-recommended data, and whether or not P₃ is specifically used may be selected according to the actual situation, which is not limited here in the embodiment of the present disclosure. Exemplarily, assuming that there are five to-be-recommended commodities, i.e., A, B, C, D and E at this time, and the recommendation indexes thereof are 5, 4, 7, 8 and 3 in sequence, after A, B, C, D and E are ranked according to their respective recommendation indexes, the resulting ranking results are D, C, A, B and E, the top four commodities need to be selected therefrom as recommended commodities, and the recommended commodities at this time are D, C, A and B. The specific preset number is determined according to the actual situation, which is not limited here in the embodiment of the present disclosure.

It is to be understood that the preset recommendation model is trained by using three different types of data, i.e., the recommendation display click data, the recommendation display non-click data and the recommendation non-display data, so that the accuracy of recommending of the first identity attribute information by using the preset recommendation model can be improved, and the click rate of the user can be further improved.

The embodiments of the present disclosure provide a data processing method. The method includes that: object attribute information, and historical behavior data and historical display data corresponding to the object attribute information are extracted from historical log data; historical recommendation data corresponding to the object attribute information is acquired from a historical recommendation information base, the historical recommendation data including historical display data; the historical recommendation data is searched for first historical recommendation data which is the same as the historical display data; second historical recommendation data is obtained according to the historical display data, historical behavior data and the first historical recommendation data; a preset recommendation model is trained by using the second historical recommendation data and the third historical recommendation data to obtain a trained preset recommendation model, the third historical recommendation data being historical recommendation data other than the first historical recommendation data among the historical recommendation data; and upon reception of first identity attribute information, recommendation data corresponding to the first identity attribute information is determined based on the trained preset recommendation model. By the adoption of the above implementation solution, various types of sample data are obtained by data extraction and data splicing on the historical log data and the historical recommendation data, and then the various types of sample data are used to train the preset recommendation model, so that the accuracy of prediction by using the trained model can be improved, and then the accuracy of recommendation is improved.

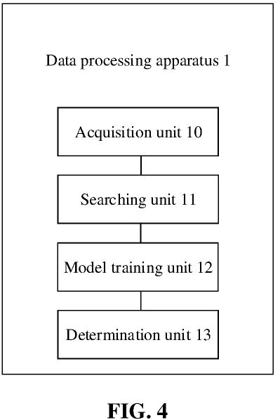

Based on the above embodiment, in another embodiment of the present disclosure, a data processing apparatus 1 is provided. FIG. 4 is a structural composition diagram of the data processing apparatus according to the present disclosure. As shown in FIG. 4, the data processing apparatus 1 includes: an acquisition unit 10, a searching unit 11, a model training unit 12, and a determination unit 13.

The acquisition unit 10 is configured to extract object attribute information, and historical behavior data and historical display data corresponding to the object attribute information from historical log data; and acquire historical recommendation data corresponding to the object attribute information from a historical recommendation information base. The historical recommendation data includes the historical display data.

The searching unit 11 is configured to search the historical recommendation data for first historical recommendation data which is the same as the historical display data; and obtain second historical recommendation data according to the historical display data, the historical behavior data and the first historical recommendation data.

The model training unit 12 is configured to train a preset recommendation model by using the second historical recommendation data and the third historical recommendation data, to obtain a trained preset recommendation model. The third historical recommendation data is historical recommendation data other than the first historical recommendation data among the historical recommendation data.

The determination unit 13 is configured to determine, upon reception of first identity attribute information, recommendation data corresponding to the first identity attribute information based on the trained preset recommendation model.

Optionally, the data processing apparatus 1 further includes: a data processing unit.

The data processing unit is configured to perform data splicing on the historical display data and the first historical recommendation data to obtain recommendation display data.

The data processing unit is further configured to classify the recommendation display data into recommendation display click data and recommendation display non-click data according to the historical behavior data; and determine the recommendation display click data and the recommendation display non-click data as the second historical recommendation data.

The model training unit 12 is further configured to train a preset recommendation model by using the recommendation display click data, the recommendation display non-click data and the recommendation non-display data, to obtain a trained preset recommendation model.

Optionally, the data processing apparatus 1 further includes: an input unit.

The input unit is configured to sequentially input each piece of data in the recommendation display click data, the recommendation display non-click data and the recommendation non-display data into a preset recommendation model to obtain a predicted recommendation display click rate, a predicted recommendation display non-click rate and a predicted recommendation non-display rate corresponding to the each piece of data.

The model training unit 12 is further configured to train the preset recommendation model based on the predicted recommendation display click rate, the predicted recommendation display non-click rate and the predicted recommendation non-display rate.

Optionally, the searching unit 11 is further configured to search a target database for to-be-recommended data corresponding to the first identity attribute information.

The input unit is further configured to input the to-be-recommended data into the trained preset recommendation model, to obtain the recommendation display click rate, and the recommendation display non-click rate and the recommendation non-display rate corresponding to the to-be-recommended data.

The determination unit 13 is further configured to determine the recommendation data corresponding to the first identity attribute information from the to-be-recommended data according to the recommendation display click rate, the recommendation display non-click rate and the recommendation non-display rate.

Optionally, the data processing apparatus 1 further includes: a ranking unit.

The determination unit 13 is further configured to determine, for each piece of the to-be-recommended data, a recommendation index according to the recommendation display click rate, the recommendation display non-click rate and the recommendation non-display rate.

The ranking unit is configured to rank the to-be-recommended data according to an order of recommendation indexes of all pieces of the to-be-recommended data from high to low to obtain the ranked to-be-recommended data.

The determination unit 13 is further configured to select a preset number of pieces of the to-be-recommended data from the ranked to-be-recommended data, and determine the preset number of pieces of the to-be-recommended data as the recommendation data corresponding to the first identity attribute information.

The embodiments of the present disclosure provide a data processing apparatus. The apparatus includes: object attribute information, historical behavior data and historical display data corresponding to the object attribute information are extracted from historical log data; historical recommendation data corresponding to the object attribute information is acquired from a historical recommendation information base, the historical recommendation data including historical display data; the historical recommendation data is searched for first historical recommendation data which is the same as the historical display data ; second historical recommendation data is obtained according to the historical display data, historical behavior data and the first historical recommendation data; a preset recommendation model is trained by using the second historical recommendation data and the third historical recommendation data, to obtain a trained preset recommendation model, the third historical recommendation data being historical recommendation data other than the first historical recommendation data among the historical recommendation data; and upon reception of first identity attribute information, recommendation data corresponding to the first identity attribute information is determined based on the trained preset recommendation model. By the adoption of the above implementation solution, various types of sample data are obtained by data extraction and data splicing on the historical log data and the historical recommendation data, and then the various types of sample data are used to train the preset recommendation model, so that the accuracy of prediction by using the trained model can be improved, and thereby the accuracy of recommendation is improved.

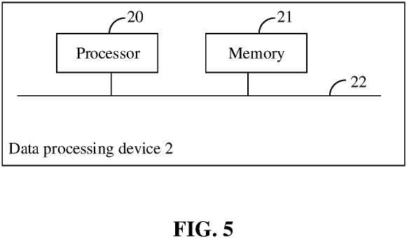

FIG. 5 is a structural composition diagram of a data processing device according to an embodiment of the present disclosure. In practical application, based on the same inventive concept of the above embodiment, as shown in FIG. 5, the data processing device 2 in the embodiment includes: a processor 20, a memory 21 and a communication bus 22.

In the specific embodiment process, the above acquisition unit 10, the searching unit 11, the model training unit 12, the determination unit 13, the data processing unit, the input unit and the ranking unit may be implemented by the processor 20 located on the data processing device 2. The above processor 20 may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a CPU, a controller, a microcontroller and a microprocessor. It is to be understood that other electronic devices may also be configured to realize functions of the processors for different data processing devices, which is not specifically limited in the embodiments of the disclosure.

In the embodiment of the present disclosure, the above communication bus 22 is configured to implement connection communication between the processor 20 and the memory 21. When executing a running program stored in the memory 21, the above processor 20 implements the following data processing method.

Object attribute information, and historical behavior data and historical display data corresponding to the object attribute information are extracted from historical log data; and historical recommendation data corresponding to the object attribute information is acquired from a historical recommendation information base. The historical recommendation data includes the historical display data.

The historical recommendation data is searched for first historical recommendation data which is the same as the historical display data; and second historical recommendation data is obtained according to the historical display data, the historical behavior data and the first historical recommendation data.

A preset recommendation model is trained by using the second historical recommendation data and the third historical recommendation data, to obtain a trained preset recommendation model. The third historical recommendation data is historical recommendation data other than the first historical recommendation data among the historical recommendation data.

Upon reception of first identity attribute information, recommendation data corresponding to the first identity attribute information is determined based on the trained preset recommendation model.

Optionally, the processor 20 is further configured to perform data splicing on the historical display data and the first historical recommendation data to obtain recommendation display data; classify the recommendation display data into the recommendation display click data and the recommendation display non-click data according to the historical behavior data; and determine the recommendation display click data and the recommendation display non-click data as the second historical recommendation data. Correspondingly, the third historical recommendation data is recommendation non-display data. The operation of training the preset recommendation model by using the second historical recommendation data and the third historical recommendation data to obtain a trained preset recommendation model includes that: the preset recommendation model is trained by using the recommendation display click data, the recommendation display non-click data and the recommendation non-display data to obtain a trained preset recommendation model.

Optionally, the processor 20 is further configured to sequentially input each piece of data in the recommendation display click data, the recommendation display non-click data and the recommendation non-display data into the preset recommendation model to obtain a predicted recommendation display click rate, a predicted recommendation display non-click rate and a predicted recommendation non-display rate corresponding to the each piece of data; and train the preset recommendation model based on the predicted recommendation display click rate, the predicted recommendation display non-click rate and the predicted recommendation non-display rate.

Optionally, the processor 20 is further configured to search a target database for to-be-recommended data corresponding to the first identity attribute information; input each piece of the to-be-recommended data into the trained preset recommendation model to obtain a recommendation display click rate, a recommendation display non-click rate and a recommendation non-display rate corresponding to the each piece of the to-be-recommended data; and determine, according to the recommendation display click rate, the recommendation display non-click rate and the recommendation non-display rate, the recommendation data corresponding to the first identity attribute information from the to-be-recommended data.

Optionally, the processor 20 is further configured to determine, for each piece of the to-be-recommended data, a recommendation index according to the recommendation display click rate, the recommendation display non-click rate and the recommendation non-display rate; rank the to-be-recommended data according to the order of recommendation indexes of all pieces of the to-be-recommended data from high to low to obtain the ranked to-be-recommended data; and select a preset number of pieces of the to-be-recommended data from the ranked to-be-recommended data, and determine the preset number of pieces of the to-be-recommended data as the recommendation data corresponding to the first identity attribute information.

The embodiment of the present disclosure provides a storage medium on which a computer program is stored. The above-mentioned computer readable storage medium stores one or more programs, and the one or more programs may be executed by one or more processors and applied to a data processing apparatus. The computer program implements the above-mentioned data processing method.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Without further restrictions, the element defined by the statement “including a...” does not exclude the existence of another same element in the process, method, article or device including the element.

Through the description of the above embodiments, those skilled in the art can clearly understand that the above embodiment method can be realized by means of software and necessary general hardware platforms. Of course, it can also be realized by hardware, but in many cases, the former is a better embodiment. Based on this understanding, the technical solution of the disclosure essentially or the part that contributes to the traditional art can be embodied in the form of a software product. The computer software product is stored in a storage medium (such as a ROM/RAM, a magnetic disc and a compact disc), including several instructions to make an image display device (which may be a mobile phone, a computer, a server, an air conditioner, or a network device, etc.) to execute the data processing method described in various embodiments of the disclosure.

The above is only the preferred embodiments of the present disclosure and not intended to limit the scope of protection of the present disclosure.

1. A data processing method, comprising:
extracting, from historical log data, object attribute information and historical behavior data and historical display data corresponding to the object attribute information;
acquiring, from a historical recommendation information base, historical recommendation data corresponding to the object attribute information, wherein the historical recommendation data comprises the historical display data;
searching the historical recommendation data for first historical recommendation data which is the same as the historical display data;
obtaining second historical recommendation data according to the historical display data, historical behavior data and the first historical recommendation data;
training a preset recommendation model by using the second historical recommendation data and third historical recommendation data, to obtain a trained preset recommendation model, wherein the third historical recommendation data is historical recommendation data other than the first historical recommendation data among the historical recommendation data; and
upon reception of first identity attribute information, determining recommendation data corresponding to the first identity attribute information based on the trained preset recommendation model.

2. The method of claim 1, wherein obtaining second historical recommendation data according to the historical display data, the historical behavior data and the first historical recommendation data comprises:
performing data splicing on the historical display data and the first historical recommendation data to obtain recommendation display data;
classifying the recommendation display data into recommendation display click data and recommendation display non-click data according to the historical behavior data; and
determining the recommendation display click data and the recommendation display non-click data as the second historical recommendation data,
wherein the third historical recommendation data is recommendation non-display data, wherein training the preset recommendation model by using the second historical recommendation data and the third historical recommendation data, to obtain the trained preset recommendation model, comprises:
training the preset recommendation model by using the recommendation display click data, the recommendation display non-click data and the recommendation non-display data, to obtain the trained preset recommendation model.

3. The method of claim 2, wherein training the preset recommendation model by using the recommendation display click data, the recommendation display non-click data and the recommendation non-display data comprises:
sequentially inputting each piece of data in the recommendation display click data, the recommendation display non-click data and the recommendation non-display data into a preset recommendation model to obtain a predicted recommendation display click rate, a predicted recommendation display non-click rate and a predicted recommendation non-display rate corresponding to the each piece of data; and
training the preset recommendation model based on the predicted recommendation display click rate, the predicted recommendation display non-click rate and the predicted recommendation non-display rate.

4. The method of claim 1, wherein determining recommendation data corresponding to the first identity attribute information based on the trained preset recommendation model comprises:
searching a target database for to-be-recommended data corresponding to the first identity attribute information;
inputting the to-be-recommended data into the trained preset recommendation model, to obtain a recommendation display click rate, a recommendation display non-click rate and a recommendation non-display rate corresponding to each piece of the to-be-recommended data; and
determining the recommendation data corresponding to the first identity attribute information from the to-be-recommended data according to the recommendation display click rate, the recommendation display non-click rate and the recommendation non-display rate.

5. The method of claim 4, wherein determining the recommendation data corresponding to the first identity attribute information from the to-be-recommended data according to the recommendation display click rate, the recommendation display non-click rate and the recommendation non-display rate comprises:
for each piece of the to-be-recommended data, determining a recommendation index according to the recommendation display click rate, the recommendation display non-click rate and the recommendation non-display rate;
ranking the to-be-recommended data according to an order of recommendation indexes of all pieces of the to-be-recommended data from high to low to obtain ranked to-be-recommended data; and
selecting a preset number of pieces of the to-be-recommended data from the ranked to-be-recommended data, and determining the preset number of pieces of the to-be-recommended data as the recommendation data corresponding to the first identity attribute information.

6. A data processing device, comprising: a processor, a memory and a communication bus, wherein the processor, when executing a running program stored in the memory, is configured to:
extract, from historical log data, object attribute information and historical behavior data and historical display data corresponding to the object attribute information;
acquire, from a historical recommendation information base, historical recommendation data corresponding to the object attribute information, wherein the historical recommendation data comprises the historical display data;
search the historical recommendation data for first historical recommendation data which is the same as the historical display data;
obtain second historical recommendation data according to the historical display data, historical behavior data and the first historical recommendation data;
train a preset recommendation model by using the second historical recommendation data and third historical recommendation data, to obtain a trained preset recommendation model, wherein the third historical recommendation data is historical recommendation data other than the first historical recommendation data among the historical recommendation data; and
upon reception of first identity attribute information, determine recommendation data corresponding to the first identity attribute information based on the trained preset recommendation model.

7. The data processing device of claim 6, wherein in order to obtain second historical recommendation data according to the historical display data, the historical behavior data and the first historical recommendation data, the processor is configured to:
perform data splicing on the historical display data and the first historical recommendation data to obtain recommendation display data;
classify the recommendation display data into recommendation display click data and recommendation display non-click data according to the historical behavior data; and
determine the recommendation display click data and the recommendation display non-click data as the second historical recommendation data,
wherein the third historical recommendation data is recommendation non-display data, wherein in order to train the preset recommendation model by using the second historical recommendation data and the third historical recommendation data, to obtain the trained preset recommendation model, the processor is configured to:
train the preset recommendation model by using the recommendation display click data, the recommendation display non-click data and the recommendation non-display data, to obtain the trained preset recommendation model.

8. The data processing device of claim 7, wherein in order to train the preset recommendation model by using the recommendation display click data, the recommendation display non-click data and the recommendation non-display data, the processor is configured to:
sequentially input each piece of data in the recommendation display click data, the recommendation display non-click data and the recommendation non-display data into a preset recommendation model to obtain a predicted recommendation display click rate, a predicted recommendation display non-click rate and a predicted recommendation non-display rate corresponding to the each piece of data; and
train the preset recommendation model based on the predicted recommendation display click rate, the predicted recommendation display non-click rate and the predicted recommendation non-display rate.

9. The data processing device of claim 6, wherein in order to determine recommendation data corresponding to the first identity attribute information based on the trained preset recommendation model, the processor is configured to:
search a target database for to-be-recommended data corresponding to the first identity attribute information;
input the to-be-recommended data into the trained preset recommendation model, to obtain a recommendation display click rate, a recommendation display non-click rate and a recommendation non-display rate corresponding to each piece of the to-be-recommended data; and
determine the recommendation data corresponding to the first identity attribute information from the to-be-recommended data according to the recommendation display click rate, the recommendation display non-click rate and the recommendation non-display rate.

10. The data processing device of claim 9, wherein in order to determine the recommendation data corresponding to the first identity attribute information from the to-be-recommended data according to the recommendation display click rate, the recommendation display non-click rate and the recommendation non-display rate, the processor is configured to:
for each piece of the to-be-recommended data, determine a recommendation index according to the recommendation display click rate, the recommendation display non-click rate and the recommendation non-display rate;
rank the to-be-recommended data according to an order of recommendation indexes of all pieces of the to-be-recommended data from high to low to obtain ranked to-be-recommended data; and
select a preset number of pieces of the to-be-recommended data from the ranked to-be-recommended data, and determine the preset number of pieces of the to-be-recommended data as the recommendation data corresponding to the first identity attribute information.

11. A non-transitory computer readable storage medium, having a computer program stored thereon, wherein the computer program, when executed by a processor, implements a data processing method, the method comprising:
extracting, from historical log data, object attribute information and historical behavior data and historical display data corresponding to the object attribute information;
acquiring, from a historical recommendation information base, historical recommendation data corresponding to the object attribute information, wherein the historical recommendation data comprises the historical display data;
searching the historical recommendation data for first historical recommendation data which is the same as the historical display data;
obtaining second historical recommendation data according to the historical display data, historical behavior data and the first historical recommendation data;
training a preset recommendation model by using the second historical recommendation data and third historical recommendation data, to obtain a trained preset recommendation model, wherein the third historical recommendation data is historical recommendation data other than the first historical recommendation data among the historical recommendation data; and
upon reception of first identity attribute information, determining recommendation data corresponding to the first identity attribute information based on the trained preset recommendation model.

12. The non-transitory computer readable storage medium of claim 11, wherein obtaining second historical recommendation data according to the historical display data, the historical behavior data and the first historical recommendation data comprises:
performing data splicing on the historical display data and the first historical recommendation data to obtain recommendation display data;
classifying the recommendation display data into recommendation display click data and recommendation display non-click data according to the historical behavior data; and
determining the recommendation display click data and the recommendation display non-click data as the second historical recommendation data,
wherein the third historical recommendation data is recommendation non-display data,
wherein training the preset recommendation model by using the second historical recommendation data and the third historical recommendation data, to obtain the trained preset recommendation model, comprises:
training the preset recommendation model by using the recommendation display click data, the recommendation display non-click data and the recommendation non-display data, to obtain the trained preset recommendation model.

13. The non-transitory computer readable storage medium of claim 12, wherein training the preset recommendation model by using the recommendation display click data, the recommendation display non-click data and the recommendation non-display data comprises:
sequentially inputting each piece of data in the recommendation display click data, the recommendation display non-click data and the recommendation non-display data into a preset recommendation model to obtain a predicted recommendation display click rate, a predicted recommendation display non-click rate and a predicted recommendation non-display rate corresponding to the each piece of data; and
training the preset recommendation model based on the predicted recommendation display click rate, the predicted recommendation display non-click rate and the predicted recommendation non-display rate.

14. The non-transitory computer readable storage medium of claim 11, wherein determining recommendation data corresponding to the first identity attribute information based on the trained preset recommendation model comprises:
searching a target database for to-be-recommended data corresponding to the first identity attribute information;
inputting the to-be-recommended data into the trained preset recommendation model, to obtain a recommendation display click rate, a recommendation display non-click rate and a recommendation non-display rate corresponding to each piece of the to-be-recommended data;
and
determining the recommendation data corresponding to the first identity attribute information from the to-be-recommended data according to the recommendation display click rate, the recommendation display non-click rate and the recommendation non-display rate.

15. The non-transitory computer readable storage medium of claim 14, wherein determining the recommendation data corresponding to the first identity attribute information from the to-be-recommended data according to the recommendation display click rate, the recommendation display non-click rate and the recommendation non-display rate comprises:
for each piece of the to-be-recommended data, determining a recommendation index according to the recommendation display click rate, the recommendation display non-click rate and the recommendation non-display rate;
ranking the to-be-recommended data according to an order of recommendation indexes of all pieces of the to-be-recommended data from high to low to obtain ranked to-be-recommended data; and
selecting a preset number of pieces of the to-be-recommended data from the ranked to-be-recommended data, and determining the preset number of pieces of the to-be-recommended data as the recommendation data corresponding to the first identity attribute information.
